(19) United States
(12) Patent Application Publication
(10) Pub. No.: US 2012/0134472 A1
(43) Pub. Date: May 31, 2012

(54) GRID FOR RADIOGRAPHY AND MANUFACTURING METHOD THEREOF, AND RADIATION IMAGING SYSTEM

(75) Inventor: Yasuhisa KANEKO, Ashigarakami-gun (JP)

(73) Assignee: FUJIFILM CORPORATION, Tokyo (JP)

(21) Appl. No.: 13/298,937

(22) Filed: Nov. 17, 2011

(30) Foreign Application Priority Data
Nov. 26, 2010 (JP) 2010-263812

(51) Int. Cl. G01N 23/20; B32B 37/02; B32B 38/00; B32B 37/12; B32B 37/14; B32B 38/10; G21K 1/02; B32B 37/10

(52) U.S. Cl. 378/70; 378/149; 156/250; 156/227

(57) ABSTRACT

In a manufacturing process of a second grid, an X-ray absorbing layer is formed on a top surface of a strip of X-ray transparent sheet during conveyance, and a buffer layer is formed on a rear surface thereof. After that, the X-ray transparent sheet is wound into a roll so as to expose the X-ray absorbing layer to outside. Thus, the X-ray transparent sheet and the X-ray absorbing layer are laminated with being bonded with the buffer layer. The roll of layer laminated structure is sliced in its radial direction into a layer laminated sheet, which has the buffer layer, the X-ray transparent sheet, and the X-ray absorbing layer laminated in layers. After polishing sliced surfaces of the layer laminated sheet, the layer laminated sheet is pressed by a pressing device, so the second grid is curved into an approximately cylindrical shape.

### BACKGROUND OF THE INVENTION

1. Field of the Invention

The present invention relates to a grid for radiography, and a manufacturing method of the grid, and a radiation imaging system using the grid.

2. Description Related to the Prior Art

When radiation, for example, X-rays are incident upon an object, the intensity and phase of the X-rays are changed by interaction between the X-rays and the object. At this time, it is known that the phase change of the X-rays is larger than the intensity change. Taking advantage of these properties of the X-rays, X-ray phase imaging is developed and actively researched. In the X-ray phase imaging, a high-contrast image (hereinafter called phase contrast image) of a sample is obtained based on the phase change (angular change) of the X-rays caused by the sample, even if the sample has low X-ray absorptivity.

There is devised an X-ray imaging system that carries out the X-ray phase imaging using the Talbot effect, which is produced with two transmissive diffraction gratings (refer to Japanese Patent Laid-Open Publication No. 2009-240378 and Applied Physics Letters Vol. 81, No. 17, page 3287 written by C. David et al. on October 2002, for example). In this X-ray imaging system, a first grid is disposed behind a sample when viewed from the side of an X-ray source, and a second grid is disposed downstream from the first grid by the Talbot distance. Behind the second grid, an X-ray image detector (FPD: flat panel detector) is disposed to detect the X-rays and produce the phase contrast image. Each of the first and second grids, being a one-dimensional grating, has narrow X-ray absorbing portions and X-ray transparent portions, which are arranged parallel to one another with aligning their edges. The Talbot distance refers to a distance at which the X-rays having passed through the first grid form a self image (fringe image) by the Talbot effect.

In the above X-ray imaging system, a fringe image, which is produced by superimposition (intensity modulation) of the second grid on the self image of the first grid, is detected by a fringe scanning method in order to obtain phase information of the sample from a change of the fringe image due to the sample. In the fringe scanning method, an image is captured whenever the second grid is translationally moved relative to the first grid in a direction approximately parallel to a surface of the first grid and approximately orthogonal to a grid direction of the first grid by a scan pitch that is an integral submultiple of a grid pitch. From a change of each and every pixel value detected by the X-ray image detector, angular distribution (a differential image of phase shift) of the X-rays refracted by the sample is obtained. Then, a phase contrast image of the sample is obtained based on the angular distribution. The fringe scanning method is also available in an imaging system using laser light (refer to Applied Optics Vol. 37, No. 26, page 6227 written by Hector Canabal et al. on September 1998, for example).

The first and second grids have minute structure in which the width and pitch of an X-ray absorbing portion are several micrometers, for example. In addition to that, the first and second grids require high X-ray absorptivity at their X-ray absorbing portions. The second grid, in particular, requires higher X-ray absorptivity than the first grid, to reliably apply the intensity modulation to the fringe image. Thus, the X-ray absorbing portions of the first and second grids are made of gold (Au) with high atomic weight. Also, the X-ray absorbing portions of the second grid need to have relatively large thickness in a propagation direction of the X-rays, in other words, a high aspect ratio (a value that the thickness of the X-ray absorbing portion is divided by the width thereof).

Since the size of the first and second grids limits the size of the phase contrast image to be captured, it is desired to increase the size of the grid. On the other hand, the X-rays emitted from the X-ray source diverge into a cone beam. Thus, if the size of the grid is increased, the vignetting of the X-rays becomes a problem in a peripheral portion of the grid. To reduce the vignetting of the X-rays by the grid, it is also desired that the X-ray absorbing portions and the X-ray transparent portions are inclined so as to converge at a focus of the X-rays.

Conventionally, there is known a method for manufacturing the grid in which two types of sheets having different X-ray absorptances are alternately laminated to form a layer laminated structure, and the layer laminated structure is sliced into the grid (refer to Japanese Patent Laid-Open Publication No. 2009-240378, for example). According to this method, it is possible to form the grid with the high aspect ratio by adjusting the thickness of the slice of the layer laminated structure.

The method described in the Japanese Patent Laid-Open Publication No. 2009-240378, however, has a problem of difficulty in handling the sheets, because the extremely thin sheets with a thickness of several micrometers have to be laminated. If the sheets kink, bend, or sag when being laminated, for example, the sheets cannot be neatly laminated without a gap. In such a case, the X-ray absorbing portions and the X-ray transparent portions have irregular widths and pitches in the completed grid, resulting in degrading the image quality of the phase contrast image.

Also, when the grid manufactured by the method of the Japanese Patent Laid-Open Publication No. 2009-240378 is made into the convergence structure, the grid has to be curved into a concave shape. However, since the curve produces stress in the grid, the X-ray absorbing portions and the X-ray transparent portions sometimes come unstuck from one another, or grid sometimes cracks. Also, when the grid is curved, an additional part for maintaining the grid in a curved state becomes necessary, and brings about increase in the size and cost of the grid.

Worse yet, when the grid is heated by irradiation with the X-rays, the X-ray absorbing portions made of the gold or the like are sometimes diffused into the X-ray transparent portions by reaction with the heat. For example, when the gold is diffused into the X-ray transparent portions, the boundary between the X-ray absorbing portion and the X-ray transparent portion becomes unclear. Thus, an intensity profile of the X-rays passed through the X-ray transparent portions becomes unclear too, and hence the grid performance is degraded.

### SUMMARY OF THE INVENTION

An object of the present invention is to provide a grid having a high aspect ratio and being resistant to damage when being curved or deformed.

To achieve the above and other objects, a grid for radiography according to the present invention includes radiation absorbing portions and radiation transparent portions alternately arranged in a plane orthogonal to a radiation propagation direction, and a buffer layer provided between the radiation absorbing portion and the radiation transparent portion. The buffer layer bonds the radiation absorbing portion and the radiation transparent portion.

The buffer layer is preferably an adhesive for bonding the radiation absorbing portion and the radiation transparent portion, and composes a part of the radiation transparent portion. The buffer layer may include an adhesive for bonding the radiation absorbing portion and the radiation transparent portion, and a radiation absorbing material dispersed in the adhesive. The buffer layer composes a part of the radiation absorbing portion. The radiation absorbing portions, the radiation transparent portions, and the buffer layer are preferably inclined so as to converge into a radiation focus from which radiation is emitted. When a first surface refers to a surface of the grid on a side of the radiation focus, and a second surface refers to a surface opposite to the first surface, a width of each of the radiation absorbing portions, the radiation transparent portions, and the buffer layer is tapered from the second surface to the first surface in an arrangement direction of the radiation absorbing portions and the radiation transparent portions. The radiation absorbing portions, the radiation transparent portions, and the buffer layer preferably extend in a direction orthogonal to an arrangement direction of the radiation absorbing portions and the radiation transparent portions.

A method for manufacturing a grid for radiography according to the present invention includes the steps of while a strip of a radio-transparent material is conveyed, forming a radiation absorbing layer on one surface of the radio-transparent material; forming a buffer layer on the other surface of the radio-transparent material or on the radiation absorbing layer during the conveyance; laminating the radio-transparent material, the radiation absorbing layer, and the buffer layer in layers to form a layer laminated structure, while the radiation absorbing layer is bonded to the radio-transparent material via the buffer layer; slicing the layer laminated structure in a lamination direction into a layer laminated sheet; and polishing a slice surface of the layer laminated sheet, so the radiation absorbing layer is formed into a radiation absorbing portion, and the radio-transparent material is formed into a radiation transparent portion.

In the laminating step, the radio-transparent material may be wound up into a roll. To invariably rotate the roll of the radio-transparent material, there may be a difference between a conveyance speed of the radio-transparent material in the forming steps of the radiation absorbing layer and the buffer layer and a winding speed in the laminating step of the radio-transparent material.

In the laminating step, the radio-transparent material is put on a flat surface, and is folded over with alternately reversing a folding direction at predetermined width intervals. The grid manufacturing method may further include the step of when the radio-transparent material is folded over predetermined number of times, or when a stack of the radio-transparent material reaches a predetermined height, pressing the layer laminated structure in the lamination direction to eliminate a gap left in a folded portion of the radio-transparent material.

The grid manufacturing method may further include the step of before the slicing step, pressing the layer laminated structure in the lamination direction by a pressing device that has a pair of pressing surfaces inclined relative to the lamination direction of the radio-transparent material, so that the lamination direction and thickness of the radio-transparent material, the buffer layer, and the radiation absorbing layer are unevenly distributed in the layer laminated structure.

A radiation imaging system according to the present invention uses the grid described above.

According to the grid of the present invention, the buffer layer is provided between the radiation absorbing portion and the radiation transparent portion, and bonds them. The buffer layer absorbs stress occurring in the grid, when the grid is curved into a convergence structure. This prevents the breakage of the grid, such as unstuck between the radiation absorbing portion and the radiation transparent portion, and a crack of the grid. The buffer layer also prevents the diffusion of the radiation absorbing portions into the radiation transparent portions by reaction of heat, when the grid is heated by irradiation with the radiation. Therefore, the boundaries between the X-ray absorbing portions and the X-ray transparent portions do not become unclear, and high grid performance is maintained.

Also, since the buffer layer composes a part of the radiation transparent portion or the radiation absorbing portion, the provision of the buffer layer does not degrade the grid performance.

Furthermore, the radiation absorbing portions, the radiation transparent portions, and the buffer layer are inclined so as to converge into the radiation source from which the radiation is emitted, and has a width gradually increasing from the first surface on the side of the radiation source to the second surface opposite to the first surface. Thus, the cone bean of X-rays transmits through the grid without undue vignetting. Also, eliminating the need for curving the grid into the convergence structure can simplify the structure of the grid.

According to the grid manufacturing method of the present invention, the radiation absorbing layer and the buffer layer are formed on the strip of radio-transparent material during conveyance. The layer laminated structure composed of the stack of the radio-transparent material is sliced in its lamination direction. Thus, it is possible to easily manufacture the grid with a high aspect ratio. The strip of radio-transparent material is wound up into the roll, or is folded over with alternately reversing the folding direction at the predetermined width intervals. Accordingly, it is possible to prevent the occurrence of a kink, bend, or sag in the radio-transparent material during lamination, contributing to manufacture of the high-accurate grid having the radiation absorbing portions and the radiation transparent portions with high-accurate width and pitch. Furthermore, just by pressing the radio-transparent material to alter its shape, the flat grid with the convergence structure is formed. According to the radiation imaging system of the present invention, the image quality of the phase contrast image is improved by use of the high-accurate grid.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a schematic view of an X-ray imaging system;

FIG. 2A is a top plan view of a second grid according to a first embodiment;

FIG. 2B is a cross sectional view of the second grid taken along line I-I of FIG. 2A;

FIG. 3 is an explanatory view of a layer forming step and a laminating step in a grid manufacturing process;

FIG. 4 is a side view of a roll formed by the laminating step;

FIG. 5 is a cross sectional view of a layer laminated sheet that has been sliced off from the roll;

FIG. 6 is an explanatory view of a minimum radius of an X-ray transparent portion of the second grid;

FIG. 7 is an explanatory view of a curving step of the grid manufacturing process;

FIG. 8A is a top plan view of a second grid according to a second embodiment;

FIG. 8B is a cross sectional view of the second grid taken along line II-II of FIG. 8A;

FIG. 9A is a top plan view of a second grid according to a third embodiment;

FIG. 9B is a cross sectional view of the second grid taken along line III-III of FIG. 9A;

FIG. 10 is a side view of a roll produced in a grid manufacturing process of a third embodiment, and shows a portion to be sliced off from the roll;

FIG. 11 is an explanatory view of a pressing step of the grid manufacturing process according to the third embodiment;

FIG. 12 is an explanatory view of a layer forming step and a laminating step in a grid manufacturing process according to a fourth embodiment;

FIG. 13 is a cross sectional view of a layer laminated structure formed in the laminating step of the fourth embodiment;

FIG. 14 is a cross sectional view showing a folded portion of the layer laminated structure; and

FIG. 15 is an explanatory view of a pressing step in the grid manufacturing process according to the fourth embodiment.

### DESCRIPTION OF THE PREFERRED EMBODIMENTS

### First Embodiment

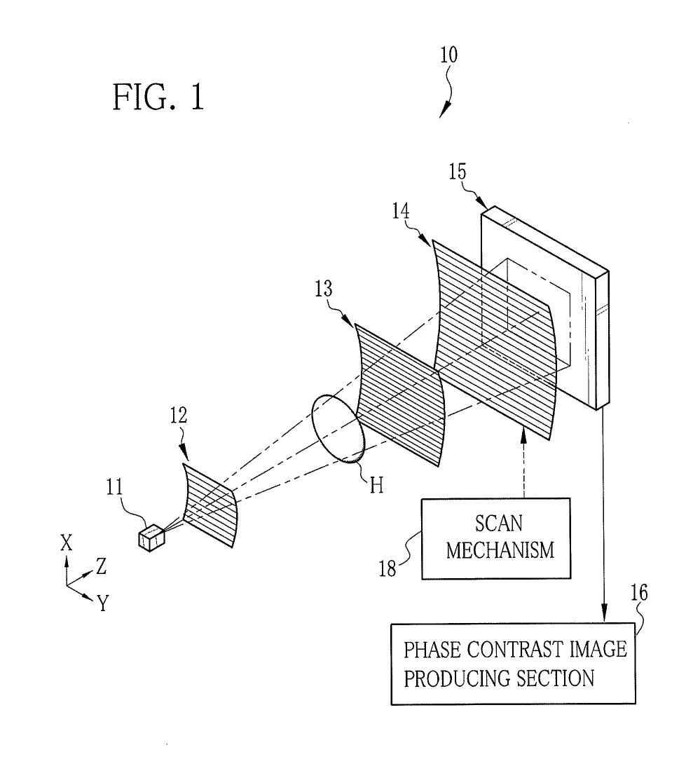

As shown in FIG. 1, an X-ray imaging system 10 is constituted of an X-ray source 11, a source grid 12, a first grid 13, a second grid 14, and an X-ray image detector 15 that are arranged in a Z direction being an X-ray propagation direction. The X-ray source 11 has, for example, a rotating anode type X-ray tube and a collimator for limiting an irradiation field of X-rays, and applies a cone beam of X-rays to a sample H. The X-ray image detector 15 is a flat panel detector (FPD) composed of semiconductor circuitry, for example, and is disposed behind the second grid 14. The X-ray image detector 15 is connected to a phase contrast image producing section (computing section) 16, which produces a phase contrast image from image data detected by the X-ray image detector 15.

The source grid 12, the first grid 13, and the second grid 14 are X-ray absorption grids, and are opposed to the X-ray source 11 in the Z direction. The first grid 13 is disposed at a certain distance away from the source grid 12 so as to place the sample H therebetween. The distance between the first grid 13 and the second grid 14 is set equal to or less than the minimum Talbot distance. In other words, the first grid 13 according to this embodiment projects the X-rays to the second grid 14 without producing the Talbot effect.

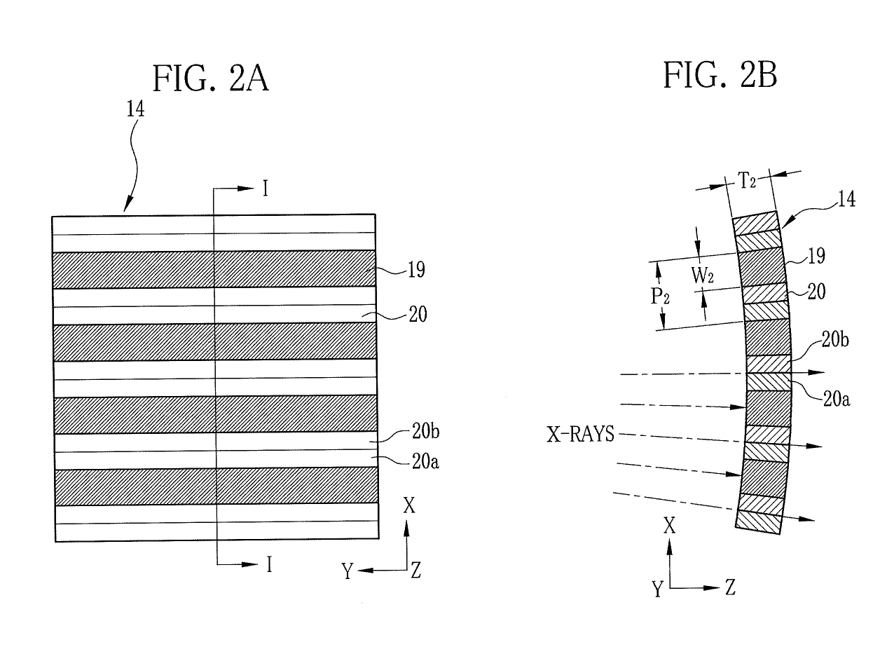

The second grid 14 and a scan mechanism 18 compose an intensity modulator of the present invention. In carrying out sequential steps of a fringe scanning method, the scan mechanism 18 translationally moves the second grid 14 by a scan pitch that is an equal division (for example, one-fifth) of a grid pitch. Referring to FIGS. 2A and 2B, the second grid 14 is curved into an approximately cylindrical shape centered on an axis that passes through an X-ray focus and extends in a Y direction. The second grid 14 is provided with plural X-ray absorbing portions 19 and X-ray transparent portions 20 extending in the Y direction. The X-ray absorbing portions 19 and the X-ray transparent portions 20 are alternately arranged in an X direction orthogonal to both the Z and Y directions, so as to form stripes of a one-dimensional grating.

The X-ray absorbing portion 19 is made of a metal with high X-ray absorptivity, such as gold, platinum, silver, or lead. The X-ray transparent portion 20 is composed of an X-ray transparent sheet 20a and a buffer layer 20b. The X-ray transparent sheet 20a adjoins to the X-ray absorbing portion 19 on one surface thereof. The buffer layer 20b connects the other surface of the X-ray transparent sheet 20a to the X-ray absorbing portion 19. Both of the X-ray transparent sheet 20a and the buffer layer 20b are made of a material with high X-ray transparency.

The buffer layer 20b is made of an adhesive having elasticity. The buffer layer 20b absorbs the stress occurring in the curved second grid 14 in order to prevent a break of the second grid 14, more specifically, to prevent the X-ray transparent portions 20 and the X-ray absorbing portions 19 from coming unstuck or to prevent the second grid 14 from cracking. Also, the buffer layer 20b has the function of preventing the diffusion of the X-ray absorbing portions 19 into the X-ray transparent portions 20 by reaction of heat, when the second grid 14 is heated by irradiation with the X-rays.

The second grid 14 is formed into curved shape, so the X-ray absorbing portions 19 and the X-ray transparent portions 20 are formed into convergence structure. In the convergence structure, the X-ray absorbing portions 19 and the X-ray transparent portions 20 are inclined in a YZ plane so as to converge at an X-ray focus (not shown) of the X-ray source 11 from which the X-rays are emitted. Accordingly, the cone beam of X-rays emitted from the X-ray source 11 passes through the second grid 14 without undue vignetting, and thus it is possible to prevent reduction of the X-ray amount due to the vignetting of the second grid 14.

The width W₂ and arrangement pitch P₂ of the X-ray absorbing portions 19 on the side of the X-ray source 11 depend on the distance between the source grid 12 and the first grid 13, the distance between the first grid 13 and the second grid 14, the arrangement pitch of the X-ray absorbing portions of the first grid 13, and the like. By way of example, the width W₂ is approximately 2 to 20 μm, and the arrangement pitch P₂ is in the order of 4 to 40 μm. In general, the thicker the thickness T₂ of the X-ray absorbing portions 19 in the Z direction, the higher the X-ray absorptivity becomes. However, in consideration of the vignetting of the cone beam of X-rays emitted from the X-ray source 11, the thickness T₂ of the X-ray absorbing portions 19 is in the order of 100 μm, for example. In this embodiment, the second grid 14 has a width W₂ of 2.5 μm, an arrangement pitch P₂ of 5 μm, and a thickness T₂ of 100 μm, and the aspect ratio of the X-ray absorbing portion 19 is 40, for example.

As with the second grid 14, each of the source grid 12 and the first grid 13 is curved into a concave shape centered on a Y-directional axis passing through the X-ray focus of the X-ray source 11. Each of the source grid 12 and the first grid 13 is provided with X-ray absorbing portions and X-ray transparent portions that extend in the Y direction and are alternately arranged in the X direction. The source grid 12 and the first grid 13 have the convergence structure, in which the X-ray absorbing portions and the X-ray transparent portions are inclined in the YZ plane so as to converge at the X-ray focus 11a, as in the case of the second grid 14. As described above, the source grid 12 and the first grid 13 have substantially the same structure as that of the second grid 14 except for the width and arrangement pitch of the X-ray absorbing portions and the X-ray transparent portions in the X direction and the thickness thereof in the Z direction, so the detailed description thereof is omitted.

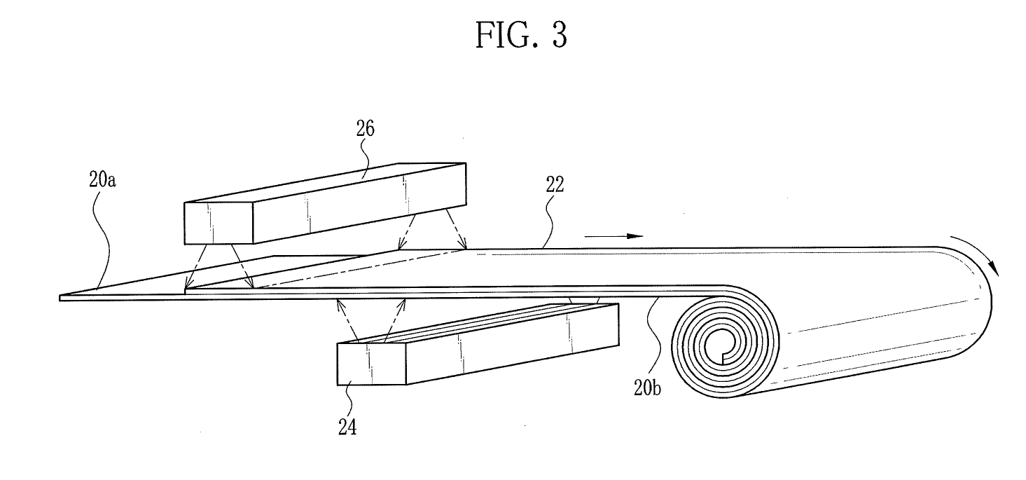

Next, a grid manufacturing process according to the present invention will be described with taking the second grid 14 as an example. As shown in FIG. 3, in a first step, while a strip of X-ray transparent sheet 20a is conveyed in an arrow direction, an X-ray absorbing layer 22 is formed on a top surface of the X-ray transparent sheet 20a, and the buffer layer 20b is formed on a rear surface of the X-ray transparent sheet 20a. The X-ray transparent sheet 20a having the X-ray absorbing layer 22 and the buffer layer 20b is wound up into a roll in such a manner as to expose the X-ray absorbing layer 22 to the outside. Thereby, the X-ray transparent sheet 20a and the X-ray absorbing layer 22 adhere via the buffer layer 20b, so the buffer layer 20b, the X-ray transparent sheet 20a, and the X-ray absorbing layer 22 are laminated.

Adopting this laminating method, in other words, winding the X-ray transparent sheet 20a into the roll less induces a kink, bend, or sag in the X-ray transparent sheet 20a than a conventional method of laminating the thin sheets, and contributes the tight lamination of the X-ray transparent sheet 20a without occurrence of a gap. Note that, the buffer layer 20b is much thinner than the X-ray transparent sheet 20a and the X-ray absorbing layer 22.

The X-ray transparent sheet 20a is made of an organic material having X-ray transparency such as PET, polyethylene, aromatic polyamide (aramid), acrylic, polyester, polypropylene, polyimide, PEN, polylactic acid, polyphenylene sulfide, and the like, or a metal having X-ray transparency such as aluminum and the like. The buffer layer 20b is made of an organic adhesive having X-ray transparency, for example, and is applied to the rear surface of the X-ray transparent sheet 20a by a sprayer 24 disposed under a conveyance path of the X-ray transparent sheet 20a. The sum of the thicknesses of the X-ray transparent sheet 20a and the buffer layer 20b is equal to or more than the thickness of the X-ray transparent portion 20 in the X direction.

The X-ray absorbing layer 22 is made of a gold, platinum, or silver colloidal solution, for example. The X-ray absorbing layer 22 is applied to the X-ray transparent sheet 20a by a sprayer 26 disposed above the conveyance path of the X-ray transparent sheet 20a, and is dried. The thickness of the X-ray absorbing layer 22 is set equal to or larger than the width W₂ of the X-ray absorbing portion 19 of the second grid 14. Note that, the X-ray absorbing layer 22 may be formed by evaporating a metal having X-ray absorptivity such as gold, platinum, or silver, or by a slit coating.

It is conceivable that the X-ray transparent sheet 20a, and the buffer layer 20b and the X-ray absorbing layer 22 formed on the X-ray transparent sheet 20a are pressed and thinned when being wound into the roll due to a lamination load. For this reason, it is preferable that the roll of the X-ray transparent sheet 20a is invariably rotated to prevent the application of the lamination load to just one part of the roll. To invariably rotate the roll of the X-ray transparent sheet 20a, it is preferable that a conveyance speed of the X-ray transparent sheet 20a during formation of the buffer layer 20b and the X-ray absorbing layer 22 is set faster than a winding speed thereof, and a speed buffering section for absorbing a speed difference is provided between a layer forming section and a winding section.

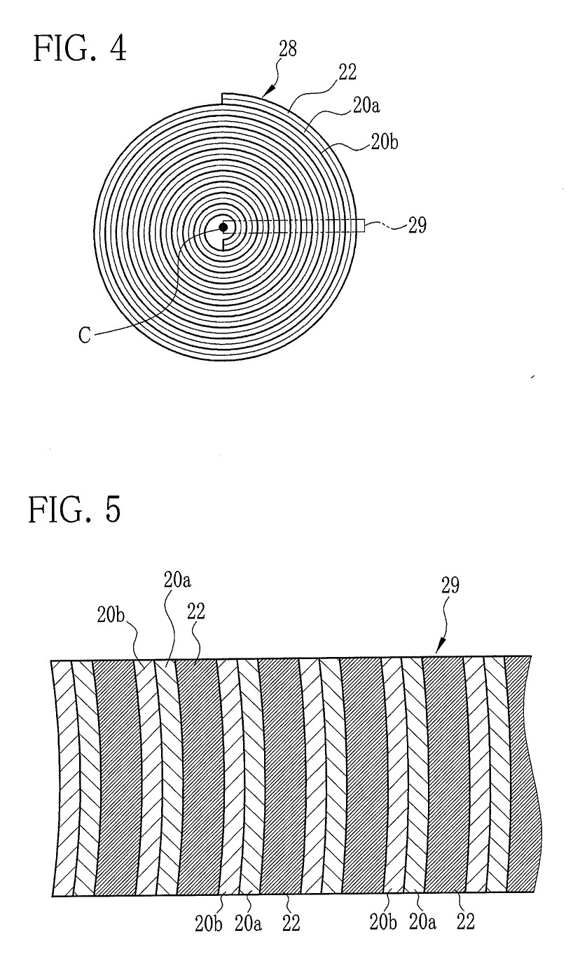

As shown in FIG. 4, in the next step, a roll 28 into which the X-ray transparent sheet 20a is wound as a layer laminated structure is cut in a radial direction as shown in a chain double-dashed line to form a layer laminated sheet 29 shown in FIG. 5. The layer laminated sheet 29 is constituted of the buffer layer 20b, the X-ray transparent sheet 20a, and the X-ray absorbing layer 22 that are stacked in this order in layers from the side of an inner periphery of the roll 28. In slicing the layer laminated sheet 29 from the roll 28, slice surfaces of the X-ray transparent sheet 20a, the buffer layer 20b, and the X-ray absorbing layer 22 become crushed. Thus, the slice surfaces are polished after being sliced. In consideration of a portion to be polished off, the layer laminated sheet 29 is sliced with a thickness larger than the above thickness T₂. Note that, a plurality of layer laminated sheet 29 are formed from the single roll 28 with the least waste.

In the layer laminated sheet 29, the X-ray absorbing portion 19 composed of the X-ray absorbing layer 22 and the X-ray transparent portion 20 composed of the X-ray transparent sheet 20a and the buffer layer 20b are curved. If a radius of curvature of the X-ray absorbing portions 19 and the X-ray transparent portions 20 is too small, the X-ray transparency and the X-ray absorptivity are degraded, resulting in a deterioration of grid performance. Thus, the minimum radius of curvature of the X-ray absorbing portions 19 and the X-ray transparent portions 20 is preferably determined in accordance with the grid to be manufactured.

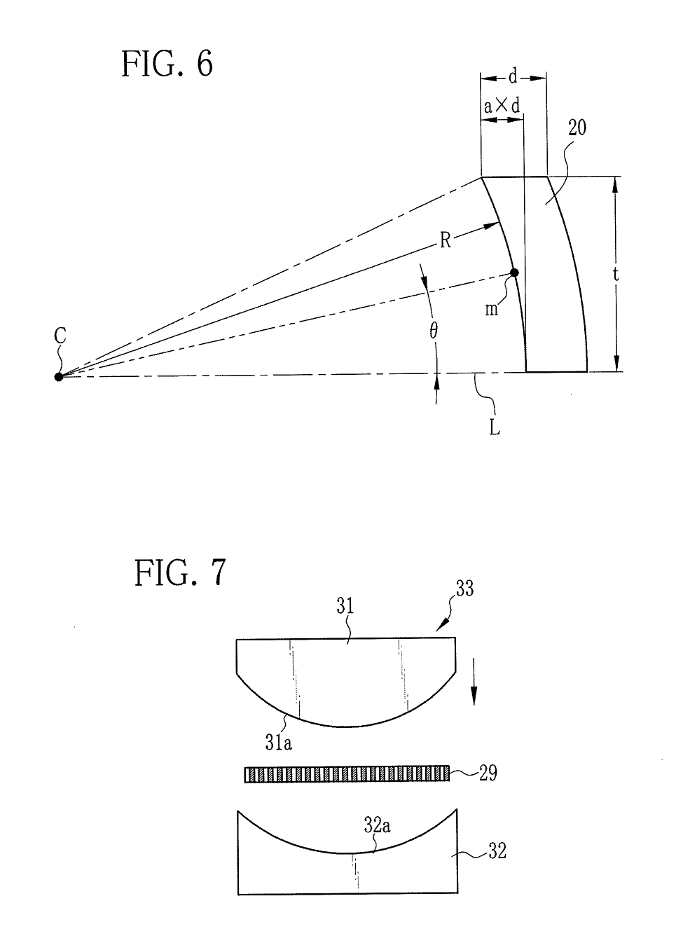

FIG. 6 shows the innermost X-ray transparent portion 20 of the layer laminated sheet 29. The innermost X-ray transparent portion 20 has a grid thickness “t”, a grid width “d”, and a grid radius “R”. “a” represents an allowance of the grid width “d”, and a minimum allowable width at which the innermost X-ray transparent portion 20 functions as apart of the grid is obtained by “a×d”. “θ” represents an angle that abase line “L” connecting the center “C” of the grid radius “R” and one end of the X-ray transparent portion 20 in the direction of the grid thickness “t” forms with a line connecting the center “C” and a midpoint “m” of the X-ray transparent portion 20 in a circumferential direction.

In the layer laminated sheet 29 having the innermost X-ray transparent portion 20 as described above, for example, the angle “θ” is obtained by the following expression (1), and the minimum grid radius “R” is obtained by the following expression (2).

θ=tan⁻¹(a·d/t) (1)

R≧t/(2·sin θ·cos θ) (2)

When the grid thickness “t” is 100 μm, the grid width “d” is 2.5 μm, and the allowance “a” is 0.1, the grid radius “R” is 20 mm or more, for example. Accordingly, to use the innermost periphery of the roll 28 as the grid, the minimum radius of the roll 28 is set at 20 mm or more. On the other hand, when the minimum radius of the roll 28 is too small to use as the grid, a part of the layers that extends from the middle of the roll 28 in the radial direction and has a radius of 20 mm or more is used.

In the next step, as shown in FIG. 7, the layer laminated sheet 29 is pressed by a pressing device 33, which is provided with a pair of pressing plates 31 and 32 having cylindrical pressing surfaces 31a and 32a, respectively, to curve the second grid 14 into an approximately cylindrical shape. At this time, in the layer laminated sheet 29, the buffer layers 20b absorb stress occurring in the second grid 14. This prevents the X-ray absorbing portion 19 and the X-ray transparent portion 20 from coming unstuck, or prevents the second grid 14 from cracking. Note that, the second grid 14 may be caught in curved support boards or the like, which are made of a material having the X-ray transparency.

Since the source grid 12 and the first grid 13 are manufactured in a like manner as the second grid 14, the detailed description thereof will be omitted.

Next, the operation of the X-ray imaging system 10 will be described. The X-rays emitted from the X-ray source 11 are partly blocked by the X-ray absorbing portions of the source grid 12, to reduce an effective focus size in the X direction and form a lot of line sources (dispersed light sources) in the X direction. When the X-rays from each of the many line sources formed by the source grid 12 pass through the sample H, phase difference arises in the X-rays. Subsequently, when the X-rays transmits through the first grid 13, a fringe image (first periodic pattern image) is formed. The fringe image includes transmission phase information of the sample H, which is determined by the refractive index of the sample H and the length of a transmission optical path. The fringe images of every line source are projected onto the second grid 14, and are combined (superimposed) at the position of the second grid 14.

The intensity of the fringe image is modified by the second grid 14. Then, the fringe image (second periodic pattern image) after the intensity modulation is detected by, for example, the fringe scanning method. In the fringe scanning method, the second grid 14 is translationally moved by the scan mechanism 18 relative to the first grid 13 by the scan pitch that is the equal division (for example, one-fifth) of the grid pitch in a direction along a grid surface with respect to the X-ray focus. Whenever the second grid 14 is translationally moved, the X-ray source 11 applies the X-rays to the sample H, and the X-ray image detector 15 captures a fringe image. Then, the phase contrast image producing section 16 produces the differential phase image (corresponding to angular distribution of the X-rays refracted by the sample H) from a phase shift amount (a shift amount in phase between in the presence of the sample H and in the absence of the sample H) of pixel data of each pixel detected by the X-ray image detector 15. The differential phase image is integrated along a fringe scanning direction to obtain the phase contrast image of the sample H.

As described above, the source grid 12, the first grid 13, and the second grid 14 according to this embodiment have the convergence structure in which the X-ray absorbing portions 19 and the X-ray transparent portions 20 are inclined in the YZ plane so as to converge at the X-ray focus 11a. Thus, it is possible to reduce the vignetting of the cone beam of X-rays. As a result, the image quality of the phase contrast image is improved in the X-ray imaging system 10 using the source grid 12, the first grid 13, and the second grid 14 of the present invention.

Also, in the source grid 12, the first grid 13, and the second grid 14 of this embodiment, the buffer layer 20b absorbs the stress of the grid. This prevents the breakage of the second grid 14, such as unstuck between the X-ray absorbing portion 19 and the X-ray transparent portion 20, or a crack of the second grid 14. Furthermore, when the grid is heated with irradiation with radiation, the buffer layer 20b prevents the diffusion of the X-ray absorbing portions 19 into the X-ray transparent portions 20, which is caused by reaction with the heat. Accordingly, the boundaries between the X-ray absorbing portions 19 and the X-ray transparent portions 20 do not become unclear, and high grid performance is maintained.

According to the grid manufacturing method of the present invention, the X-ray transparent sheet 20a having the buffer layer 20b and the X-ray absorbing layer 22 formed thereon is wound into the roll, and the layer laminated sheet 29 is sliced from the roll to form the grid. This method allows easy manufacture of the grid with the high aspect ratio. Furthermore, when the grid is curved and formed into the convergence structure, the buffer layer 20b absorbs the stress of the grid, preventing the breakage of the grid during a curving step. Also, since the grid is flexibly curved owing to the buffer layer 20b, the grid with the fine curved shape can be formed.

In the above embodiment, the buffer layer 20b is formed on the X-ray transparent sheet 20a, but may be formed on the X-ray absorbing layer 22, instead. In this case, the X-ray absorbing layer 22 may be applied on the X-ray transparent sheet 20a and dried, and then the X-ray transparent sheet 20a may be temporarily wound up. After that, the X-ray transparent sheet 20a may be drawn again to form the buffer layer 20b on the X-ray absorbing layer 22.

### Second Embodiment

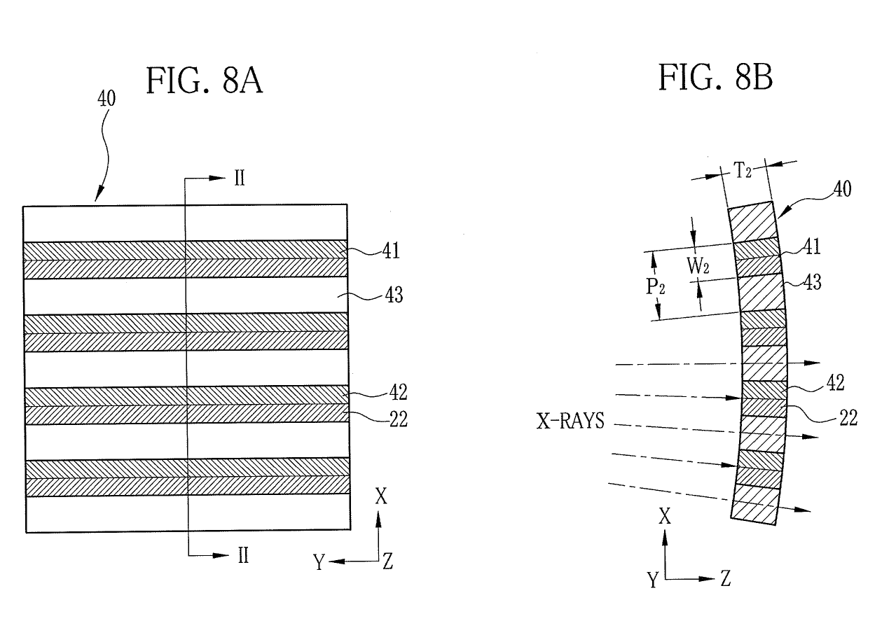

In the above first embodiment, the X-ray transparent portion 20 is composed of the X-ray transparent sheet 20a and the buffer layer 20b. However, as shown in a second grid 40 of FIGS. 8A and 8B, an X-ray absorbing portion 41 may be composed of the X-ray absorbing layer 22 and a buffer layer 42, instead. In this case, an X-ray absorbing material made of gold, platinum, silver, or lead is dispersed into an adhesive for forming the buffer layer 42, in order to impart the X-ray absorptivity to the buffer layer 42. The X-ray transparent sheet 20a is formed so as to have a thickness corresponding with the thickness of an X-ray transparent portion 43. The sum of the thicknesses of the X-ray absorbing layer 22 and the buffer layer 42 corresponds with the thickness of the X-ray absorbing portion 41. The second grid 40 of the second embodiment has the same structure as the second grid 14 of the first embodiment except for the layer structure of the X-ray absorbing portions 41 and the X-ray transparent portions 43, so the detailed description thereof is omitted.

According to the second grid 40 of this embodiment, as in the case of the second grid 14 of the first embodiment, it is possible to reduce the vignetting of the cone beam of X-rays, and improve the image quality of the phase contrast image. Also, the buffer layer 42 prevents the breakage of the grid during manufacture or use by absorbing stress occurring in the grid, and also prevents the diffusion of the X-ray absorbing layer 22 into the X-ray transparent portions 43.

### Third Embodiment

In the above embodiments, the grid with the convergence structure is formed by curving the layer laminated sheet 29 sliced out of the roll, but a flat grid with the convergence structure may be formed. A third embodiment of the present invention will be hereinafter described. In the following description, the reference numerals same as those of the first and second embodiments refer to the same components, and detailed description thereof will be omitted.

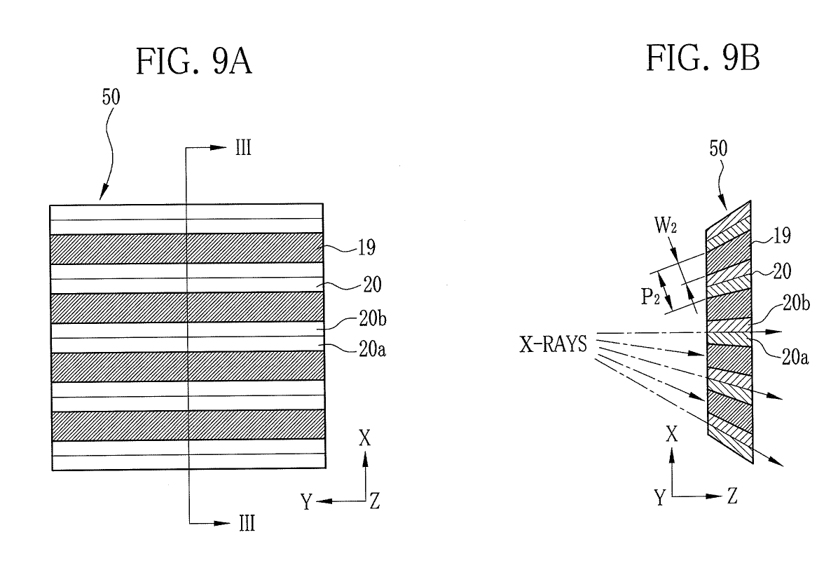

As shown in FIGS. 9A and 9B, a second grid 50 according to the third embodiment has the plural X-ray absorbing portions 19 and the plural X-ray transparent portions 20 that extend in the Y direction and are arranged alternately in the X direction. The X-ray transparent portion 20 is composed of the X-ray absorbing sheet 20a and the buffer layer 20b. The second grid 50 has the convergence structure in which the X-ray absorbing portions 19 and the X-ray transparent portions 20 are inclined in the YZ plane so as to converge at the X-ray focus of the X-ray source 11, and have a width gradually increasing from a first surface being the side of the X-ray source 11 to a second surface being the side of the X-ray image detector 15 opposite to the first surface. Thus, the cone beam of X-rays emitted from the X-ray source 11 transmits through the second grid 50 without undue vignetting, and thus it is possible to prevent reduction of the X-ray amount due to the vignetting of the second grid 50.

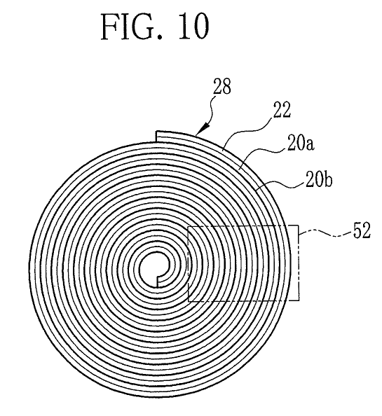

Next, a manufacturing process of the second grid 50 will be described. As shown in FIG. 10, in this embodiment, the roll 28 is cut out into a layer laminated structure 52 that is thicker than the layer laminated structure 29 of the first embodiment. Note that, one or plural layer laminated structures 29 are formed from the single roll 28 in accordance with the size of the roll 28.

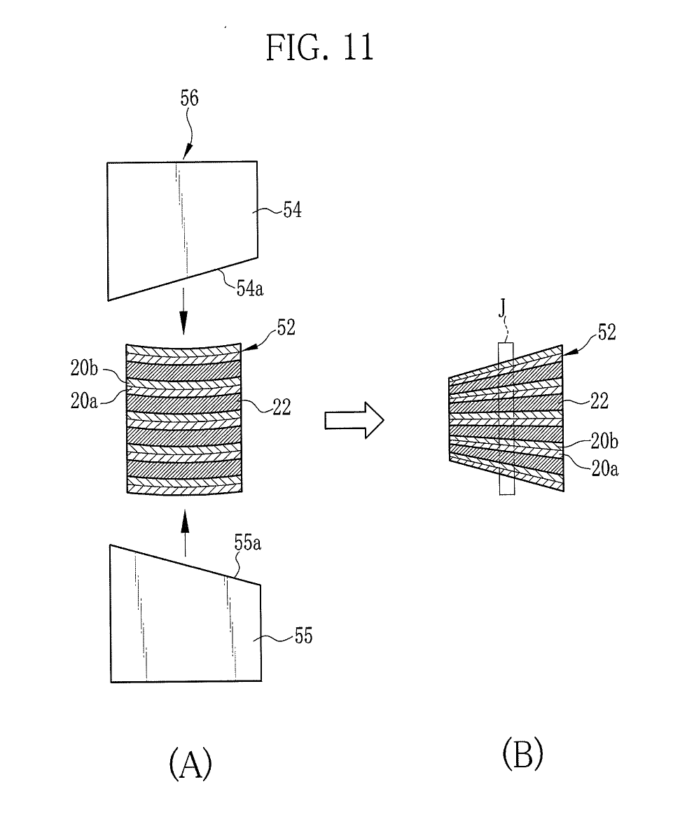

As shown in FIG. 11(A), in the next step, the layer laminated structure 52 is pressed into a tapered shape by a pressing device 56 having a pair of pressing members 54 and 55. The pair of pressing members 54 and 55 are movable in directions approaching each other from the top and bottom of the layer laminated structure 52 as indicated by arrows. The pressing members 54 and 55 have pressing surfaces 54a and 55a, respectively, which are inclined relative to the movement direction of the pressing member 54 and 55. The layer laminated structure 52 is disposed between the pair of pressing members 54 and 55 in such a manner that a lamination direction of the X-ray transparent sheet 20a and the like coincides with the movement direction of the pair of pressing members 54 and 55.

When the pressing members 54 and 55 move in the arrow directions so as to approach each other, the pressing surfaces 54a and 55a press and alter the layer laminated structure 52 into a trapezoidal shape. Thus, thickness distribution is changed in the X-ray transparent sheet 20a, the buffer layer 20b, and the X-ray absorbing layer 22, such that the thickness of each of the X-ray transparent sheet 20a, the buffer layer 20b, and the X-ray absorbing layer 22 gradually increases from a parallel short side of the trapezoid to a parallel long side thereof. Also, the X-ray transparent sheet 20a, the buffer layer 20b, and the X-ray absorbing layer 22 are inclined so as to converge at the X-ray focus.

In the next step, as shown in the right of FIG. 11(B), the layer laminated structure 52 taking the trapezoidal shape is sliced as shown by a chain double-dashed line J, and slice surfaces are polished. The width of the slice is thicker than the thickness T2 of the second grid 50, for example, in consideration of a portion to be polished off. In this manner, the second grid 50 of the flat convergence structure is completed that has the X-ray absorbing portions 19 composed of the X-ray absorbing layer 22, and the X-ray transparent portions 20 composed of the X-ray transparent sheet 20a and the buffer layer 20b.

According to the second grid 50 of this embodiment, as in the cases of the first and second embodiments, it is possible to reduce the vignetting of the cone beam of X-rays, and improve the image quality of the phase contrast image. Also, the buffer layer 20b absorbs the stress of the grid 50, and prevents the breakage of the grid 50 during manufacture and use. The buffer layer 20b also prevents the diffusion of the X-ray absorbing layer 22 into the X-ray transparent portions 20.

Since the source grid and the first grid are manufactured in a like manner, the detailed description thereof will be omitted. In the grid of this embodiment, as in the case of the second embodiment, the X-ray absorbing portion may be composed of the X-ray absorbing layer and the buffer layer in which the X-ray absorbing material is dispersed.

### Fourth Embodiment

The X-ray transparent sheet 20a is wound up into the roll in each of the above embodiments. The X-ray transparent sheet 20a may be folded instead, to laminate the X-ray transparent sheet 20a, the buffer layer 20b, and the X-ray absorbing layer 22. An embodiment of folding the X-ray transparent sheet 20a will be hereinafter described. In the following description, the reference numerals same as those of the first to third embodiments refer to the same components, and detailed description thereof will be omitted.

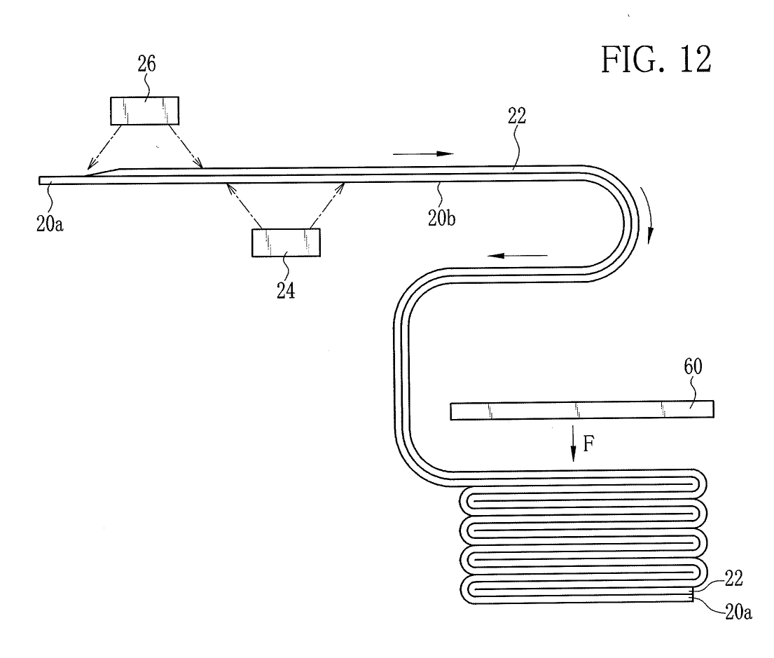

As shown in FIG. 12, in this embodiment, while the strip of X-ray transparent sheet 20a is conveyed in an arrow direction, the X-ray absorbing layer 22 is formed on the top surface of the X-ray transparent sheet 20a by the sprayer 26, and the buffer layer (adhesive layer) 20b is formed on the rear surface of the X-ray transparent sheet 20a by the sprayer 24.

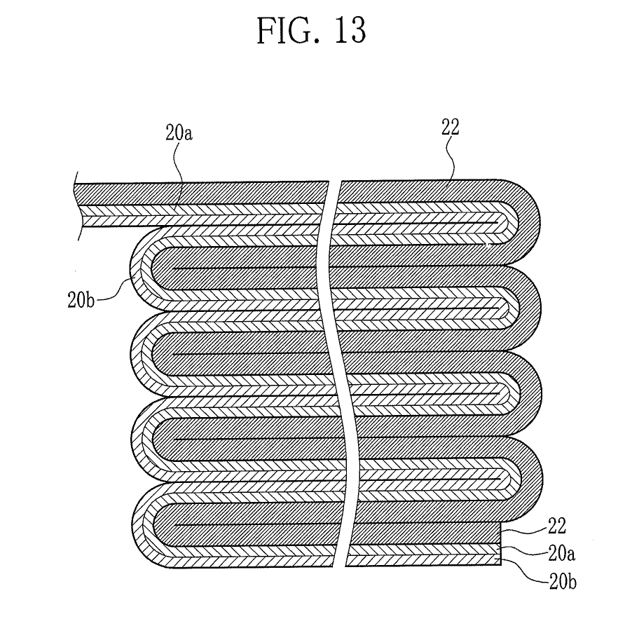

The X-ray transparent sheet 20a that has the X-ray absorbing layer 22 and the buffer layer 20b formed is put on a not-shown flat table. Then, the X-ray transparent sheet 20a is folded over with reversing a folding direction at predetermined intervals, such that the X-ray absorbing layer 22 and the buffer layer 20b are alternately face down to the inside. More specifically, as shown in FIG. 13, the buffer layer 20b, the X-ray transparent sheet 20a, and the X-ray absorbing layer 22 are firstly stacked in this order from the bottom, and then the X-ray absorbing layer 22, the X-ray transparent sheet 20a, and the buffer layer 20b are stacked in this order from the bottom. In this manner, the layers are stacked with reversing the folding direction of the X-ray transparent sheet 20a. According to this method, the X-ray absorbing layer 22 lies on the top of itself, and the buffer layer 20b lies on top of itself. Thus, the thickness of the X-ray absorbing layer 22 is preferably set at half of the thickness of the X-ray absorbing portion to be manufactured. The thickness of the sum of the X-ray transparent sheet 20a and the buffer layer 20b is preferably set at half of the thickness of the X-ray transparent portion to be manufactured.

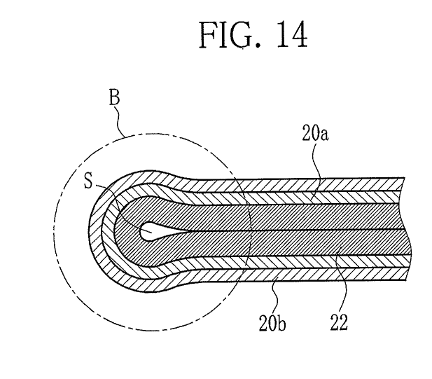

Since the X-ray transparent sheet 20a and the X-ray absorbing layer 22 possess high stiffness, a gap S is left in a folded portion B of the X-ray transparent sheet 20a, as shown in FIG. 14. Therefore, when the X-ray transparent sheet 20a is folded over predetermined times, or a stack of the X-ray transparent sheet 20a reaches a predetermined height, as shown in FIG. 12, a pressing board 60 is pressed against the topmost layer of the stack of the X-ray transparent sheet 20a to eliminate the gaps S left in the folded portions B of the X-ray transparent sheet 20a and the X-ray absorbing layer 22. A pressing force F exerted by the pressing board 60 on the X-ray transparent sheet 20a is obtained by the following expression (3),

F≧N×F_{A} (3)

Wherein F_{A} represents a force necessary for folding over the single folded portion B of the X-ray transparent sheet 20a so as to eliminate the gap S, and N represents the number of folding over the X-ray transparent sheet 20a, that is, the number of the folded portions B.

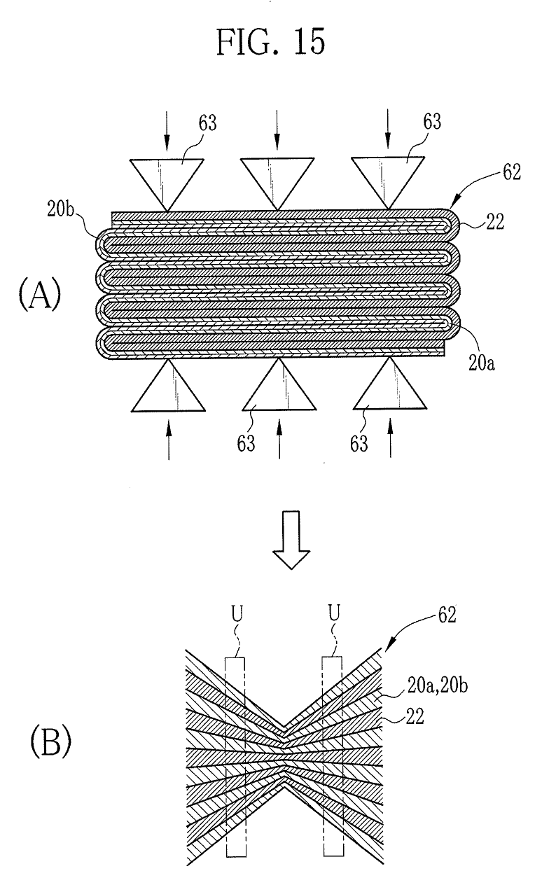

After the X-ray transparent sheet 20a is laminated, a layer laminated structure of the X-ray transparent sheet 20a may be pressed and made into a trapezoidal shape by the pressing device 56, and the trapezoidal layer laminated structure may be sliced to form the second grid 50 having the convergence structure, as in the case of the third embodiment. In another case, as shown in FIG. 15(A), a layer laminated structure 62 of the X-ray transparent sheet 20a may be pressed by plural pairs of wedge-shaped pressing members 63, which are disposed in an opposed manner along the lamination direction of the X-ray transparent sheet 20a. When being pressed by the wedge-shaped pressing members 63, the layer laminated structure 62 is made into a corrugated shape. As shown in FIG. 15(B), each layer of the layer laminated structure 62 is inclined in accordance with the shape of the pressing members 63, and the thickness distribution of each layer is changed such that each layer becomes the thinnest at a portion pressed by tips of the opposed pressing members 63.

The layer laminated structure 62 after being pressed is sliced as shown in a chain double-dashed line U, and slice surfaces are polished. The thickness of the slice is thicker than the thickness T2 of the second grid 50, for example, in consideration of a portion to be polished off. In this manner, it is possible to manufacture the second grid 50 with the convergence structure, in which the X-ray absorbing portions 19 are composed of the X-ray absorbing layer 22 and the X-ray transparent portions 20 are composed of the X-ray transparent sheet 20a and the buffer layer 20b, and the X-ray absorbing portions 19 and the X-ray transparent portions 20 converge at the X-ray focus 11a and have a width gradually increasing along the X-ray propagation direction.

According to this embodiment, since the X-ray transparent sheet 20a, the buffer layer 20b, and the X-ray absorbing layer 22 are not curved, in contrast to the first and second embodiments, it is possible to manufacture the grid having high X-ray transparency and high X-ray absorptivity. The source grid and the first grid can be manufactured in a like manner, so the detailed description thereof is omitted. Also, in the grid of this embodiment, as in the case of the second embodiment, the X-ray absorbing portion may be composed of the X-ray absorbing layer and the buffer layer in which the X-ray absorbing material is dispersed.

In this embodiment, the second grid 50 with the convergence structure is formed by pressing and altering the shape of the layer laminated structure 62. However, a parallel grid may be formed without performing a pressing step, as in the case of the first embodiment, and the parallel grid may be curved. In this case, since the X-ray transparent sheet 20a and the like are stacked on a flat surface in this embodiment, it is not necessary to consider the curvature of the X-ray absorbing portions and the X-ray transparent portions occurring in stacking them into the roll.

The above embodiments are described with taking as an example a one-dimensional grid with stripes, which has the X-ray absorbing portions and the X-ray transparent portions extending in one direction and being alternately arranged along an arrangement direction orthogonal to the extending direction. The present invention, however, is applicable to a two-dimensional grid in which the X-ray absorbing portions and the X-ray transparent portions are arranged in two directions. Furthermore, in the above embodiments, the sample is disposed between the X-ray source and the first grid. However, if the sample is disposed between the first grid and the second grid, the phase contrast image can be produced in a like manner. The X-ray imaging system has the source grid, but the present invention is applicable to an X-ray imaging system without using the source grid. The above embodiments can be combined with each other, as long as a contradiction does not arise.

In the above embodiments, the first grid linearly projects the X-rays that have passed through its X-ray transparent portions, but the present invention is not limited to this structure. The first grid may diffract the X-rays, and produce the so-called Talbot effect (refer to International Publication No. WO2004/058070). In this case, the distance between the first and second grids has to beset at the Talbot distance. The first grid maybe a phase grid having a relatively low aspect ratio, instead of an absorption grid.

In the above embodiments, after the second grid applies the intensity modulation to the fringe image, the fringe image is detected by the fringe scanning method to produce the phase contrast image. However, there is known an X-ray imaging system that produces the phase contrast image by single image capture operation. For example, according to an X-ray imaging system disclosed in International Publication No. WO2010/050483, moiré produced by first and second grids is detected by an X-ray image detector. The intensity distribution of the detected moiré is applied to the Fourier transform to obtain a spatial frequency spectrum. From the spatial frequency spectrum, a spectrum corresponding to a carrier frequency is separated, and the separated spectrum is applied to the inverse Fourier transform to obtain the phase differential image. The grid of the present invention maybe used as at least one of the first and second grids of the X-ray imaging system of this type.

In another type of X-ray imaging system that produces the phase contrast image from the single image capture operation, a direct conversion type of X-ray image detector is used as the intensity modulator instead of the second grid. The direct conversion type of X-ray image detector is provided with a conversion layer for converting the X-rays into electric charge, and a charge collection electrode for collecting the electric charge converted by the conversion layer. In this X-ray imaging system, the charge collection electrode of each pixel is composed of plural linear electrode groups arranged out of phase from one another. Each linear electrode group includes linear electrodes arranged with a period approximately coinciding with a periodic pattern of a fringe image formed by the first grid, and the linear electrodes are electrically connected to each other. By separately controlling the plural linear electrode groups and collecting the electric charge, a plurality of fringe images are obtained in the single image capture operation. The phase contrast image is produced based on the plural fringe images (refer to U.S. Pat. No. 7,746,981 corresponding to Japanese Patent Laid-Open Publication No. 2009-133823).

In further another type of X-ray imaging system that produces the phase contrast image in the single image capture operation, the first and second grids are disposed such that the extending direction of the X-ray absorbing portions and the X-ray transparent portions is relatively inclined by a predetermined angle. A section of moiré that emerges in the extending direction due to the inclination is divided, and an image of each divided section is captured. Thereby, a plurality of fringe images are obtained with the different relative position between the first and second grids, and the phase contrast image is produced from the plural fringe images. The grid of the present invention may be used as at least one of the first and second grids of this type of X-ray imaging system.

There is another type of X-ray imaging system that uses an optical reading type of X-ray image detector instead of the second grid. This system uses the optical reading type of X-ray image detector as the intensity modulator. The optical reading type of X-ray image detector is constituted of a first electrode layer for transmitting a periodic pattern image formed by the first grid, a photoconductive layer for generating electric charge upon receiving the incident of the periodic pattern image transmitted through the first electrode layer, a charge accumulating layer for accumulating the electric charge generated in the photoconductive layer, and a second electrode layer in which many linear electrodes for transmitting reading light are arranged that are stacked in this order. By scanning with the reading light, an image signal of each pixel, which corresponds to each linear electrode, is read out. If the charge accumulating layer is formed into a grating with a pitch finer than the arrangement pitch of the linear electrodes, the charge accumulating layer can function as the second grid. The grid of the present invention may be used as the first grid of this type of X-ray imaging system.

The embodiments described above are applicable not only to a radiation imaging system for medical diagnosis, but also to other types of radiation imaging systems for industrial use, nondestructive inspection, and the like. The present invention is also applicable to a grid for removing scattered light in radiography. Furthermore, in the present invention, gamma-rays may be used as the radiation instead of the X-rays.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A grid for radiography comprising:
radiation absorbing portions and radiation transparent portions alternately arranged in a plane orthogonal to a radiation propagation direction; and
a buffer layer provided between said radiation absorbing portion and said radiation transparent portion, for bonding said radiation absorbing portion and said radiation transparent portion.

2. The grid according to claim 1, wherein said buffer layer is an adhesive for bonding said radiation absorbing portion and said radiation transparent portion, and composes a part of said radiation transparent portion.

3. The grid according to claim 1, wherein said buffer layer includes:
an adhesive for bonding said radiation absorbing portion and said radiation transparent portion; and
a radiation absorbing material dispersed in said adhesive;
wherein said buffer layer composes a part of said radiation absorbing portion.

4. The grid according to claim 1, wherein said radiation absorbing portions, said radiation transparent portions, and said buffer layer are inclined so as to converge into a radiation focus from which radiation is emitted.

5. The grid according to claim 4, wherein when a first surface refers to a surface of said grid on a side of said radiation focus, and a second surface refers to a surface opposite to said first surface, a width of each of said radiation absorbing portions, said radiation transparent portions, and said buffer layer is tapered from said second surface to said first surface in an arrangement direction of said radiation absorbing portions and said radiation transparent portions.

6. The grid according to claim 1, wherein said radiation absorbing portions, said radiation transparent portions, and said buffer layer extend in a direction orthogonal to an arrangement direction of said radiation absorbing portions and said radiation transparent portions.

7. A method for manufacturing a grid for radiography comprising the steps of:
while a strip of a radio-transparent material is conveyed, forming a radiation absorbing layer on one surface of said radio-transparent material;
forming a buffer layer on the other surface of said radio-transparent material or on said radiation absorbing layer during the conveyance;
laminating said radio-transparent material, said radiation absorbing layer, and said buffer layer in layers to form a layer laminated structure, while said radiation absorbing layer is bonded to said radio-transparent material via said buffer layer;
slicing said layer laminated structure in a lamination direction into a layer laminated sheet; and
polishing a slice surface of said layer laminated sheet, so said radiation absorbing layer is formed into a radiation absorbing portion, and said radio-transparent material is formed into a radiation transparent portion.

8. The method according to claim 7, wherein in the laminating step, said radio-transparent material is wound up into a roll.

9. The method according to claim 8, wherein there is a difference between a conveyance speed of said radio-transparent material in the forming steps of said radiation absorbing layer and said buffer layer and a winding speed in the laminating step of said radio-transparent material, in order to invariably rotate said roll of said radio-transparent material.

10. The method according to claim 7, wherein in the laminating step, said radio-transparent material is put on a flat surface, and is folded over with alternately reversing a folding direction at predetermined width intervals.

11. The method according to claim 10, further comprising the step of:
when said radio-transparent material is folded over predetermined number of times, or when a stack of said radio-transparent material reaches a predetermined height, pressing said layer laminated structure in said lamination direction to eliminate a gap left in a folded portion of said radio-transparent material.

12. The method according to claim 7, further comprising the step of:
before the slicing step, pressing said layer laminated structure in said lamination direction by a pressing device having a pair of pressing surfaces inclined relative to said lamination direction of said radio-transparent material, so as to unevenly distribute said lamination direction and thickness of said radio-transparent material, said buffer layer, and said radiation absorbing layer in said layer laminated structure.

13. The method according to claim 7, wherein said buffer layer is an adhesive for bonding said radio-transparent material and said radiation absorbing layer, and composes a part of said radiation transparent portion.

14. The grid according to claim 7, wherein said buffer layer includes:
an adhesive for bonding said radio-transparent material and said radiation absorbing layer; and
a radiation absorbing material dispersed in said adhesive;
wherein said buffer layer composes a part of said radiation absorbing portion.

15. A radiation imaging system comprising:
(A) a first grid for passing radiation emitted from a radiation source and forming a first periodic pattern image, said first grid including:
radiation absorbing portions and radiation transparent portions alternately arranged in a plane orthogonal to a propagation direction of said radiation; and
a buffer layer provided between said radiation absorbing portion and said radiation transparent portion, for bonding said radiation absorbing portion and said radiation transparent portion;
(B) an intensity modulator for applying intensity modulation to said first periodic pattern image in at least one of relative positions out of phase with a pattern of said first periodic pattern image;
(C) a radiation image detector for detecting a second periodic pattern image produced by said intensity modulator; and
(D) a computing section for producing an image of phase information based on said second periodic pattern image detected by said radiation image detector.

16. The radiation imaging system according to claim 15, wherein said intensity modulator includes:
a second grid for applying the intensity modulation to said first periodic pattern image, including:
radiation absorbing portions and radiation transparent portions alternately arranged in said plane orthogonal to said propagation direction of said radiation; and
a buffer layer provided between said radiation absorbing portion and said radiation transparent portion, for bonding said radiation absorbing portion and said radiation transparent portion; and
a scan mechanism for moving one of said first and second grids by a predetermined pitch to a periodic direction of a grid configuration of said first and second grids; and
wherein said scan mechanism moves one of said first and second grids to positions corresponding to said relative positions.

17. The radiation imaging system according to claim 15, further comprising:
a third grid disposed between said radiation source and said first grid, for partly blocking said radiation emitted from said radiation source to form a lot of line light sources, said third grid including:
radiation absorbing portions and radiation transparent portions alternately arranged in said plane orthogonal to said propagation direction of said radiation; and
a buffer layer provided between said radiation absorbing portion and said radiation transparent portion, for bonding said radiation absorbing portion and said radiation transparent portion.
